(19) United States
(12) Patent Application Publication
(10) Pub. No.: US 2008/0004551 A1
(43) Pub. Date: Jan. 3, 2008

(54) Device for facilitating performance of the Heimlich maneuver

(76) Inventor: Kevin R. Goodell, Portland, ME (US)

Correspondence Address: PATRICK R. SCANLON;PRETI FLAHERTY BELIVEAU & PACHIOS LLP, ONE CITY CENTER, PORTLAND, ME, 04112-9546, US

(21) Appl. No.: 11/476,289

(22) Filed: Jun. 28, 2006

(51) Int. Cl. A61H 31/00; A61H 23/00; A61H 31/02

(52) U.S. Cl. 601/41; 601/107

(57) ABSTRACT

A device for facilitating performance of the Heimlich maneuver includes a flexible belt having first and second ends and an asymmetrical protuberance formed on one side thereof between the first and second ends. The device can be placed around a choking victim with the protuberance positioned just below the sternum for assisting in applying abdominal thrusts. In one possible embodiment, the device includes a plurality of handgrips formed in the belt that allow a user to easily grasp the device when using it to perform the Heimlich maneuver.

### BACKGROUND OF THE INVENTION

This invention relates generally to performing the Heimlich maneuver and more particularly to a device for facilitating the Heimlich maneuver.

Thousands of people die every year by choking on a piece of food or other foreign object that becomes accidentally lodged in the windpipe or airway. A person choking on such an airway obstruction will die unless the obstruction can be quickly removed. Choking accidents often occur in homes, restaurants, and other places where food is served. A choking victim's life can be saved if another person on the scene recognizes that the person is choking and is capable of acting quickly to remove the obstruction.

One well-known technique for dislodging an airway obstruction in a choking victim is the Heimlich maneuver, which is sometimes also referred to as the abdominal thrust method. The Heimlich maneuver is most commonly performed by a person standing behind the choking victim and wrapping his or her arms around the victim's torso. The rescuer makes a fist with one hand, and places it, thumb toward the victim, below the rib cage and above the waist. The rescuer's other hand is placed on top of the fist. The rescuer abruptly pulls the fist upward and inward to produce a series of abdominal thrusts. Such an abdominal thrust lifts the diaphragm and forces air out of the lungs with great force so as to expel the airway obstruction. Abdominal thrusts may need to be repeated several times before the object is dislodged. Although there is some risk of injury to the choking victim, organizations such as the American Heart Association recommend the Heimlich maneuver for use in clearing a blocked airway in a conscious choking victim.

A problem occurs in performing the Heimlich maneuver if the choking victim is too large for the rescuer to wrap his or her arms around and apply sufficient force to the abdomen. In such instances, the Heimlich maneuver may not be able to be performed successfully.

### SUMMARY OF THE INVENTION

The present invention overcomes the above-mentioned problem by providing a device for facilitating performance of the Heimlich maneuver. The device includes a flexible belt having first and second ends and an asymmetrical protuberance formed on one side thereof between the first and second ends. The device can be placed around a choking victim with the protuberance positioned just below the sternum for assisting in applying abdominal thrusts. In one possible embodiment, the device includes a plurality of handgrips formed in the belt that allow a user to easily grasp the device when using it to perform the Heimlich maneuver.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is a perspective view of a device for facilitating performance of the Heimlich maneuver.

FIG. 2 is a front view of the device of FIG. 1.

FIG. 3 is a rear view of the device of FIG. 1.

FIG. 4 is a cross-sectional view of the device taken along line 4-4 of FIG. 3.

### DETAILED DESCRIPTION OF THE INVENTION

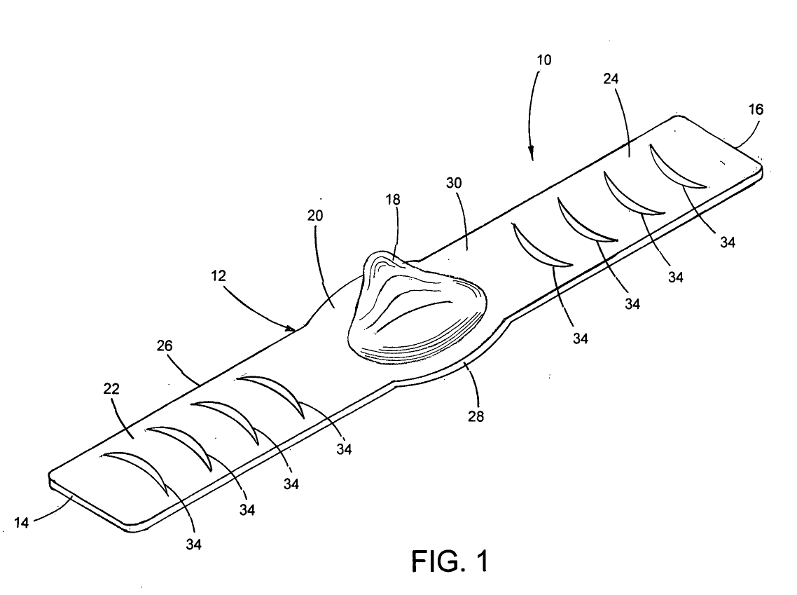

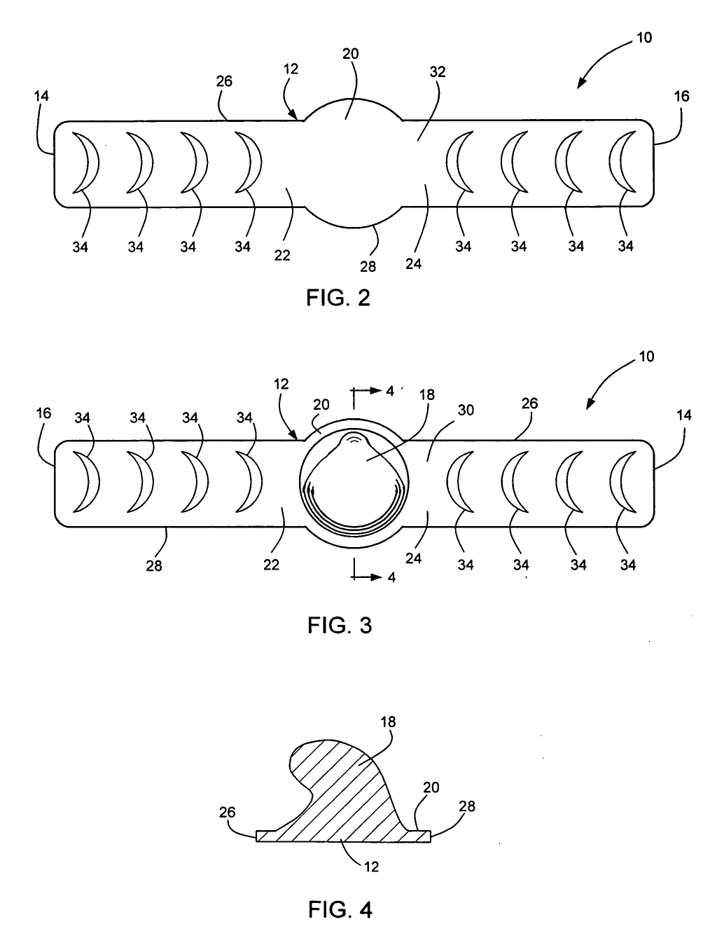

Referring to the drawings wherein identical reference numerals denote the same elements throughout the various views, FIGS. 1-4 show a device 10 that can be used to assist with applying abdominal thrusts and thus facilitate performance of the Heimlich maneuver. The device 10 includes an elongated, flexible belt 12 having first and second ends 14 and 16 and a protuberance 18 formed on a first side of the belt 12, intermediate the first and second ends 14 and 16. The device 10 can be of a unitary, one-piece construction—that is, the belt 12 and the protuberance 18 are integrally formed—or the device 10 can have a two-piece construction in which the belt 12 and the protuberance 18 are separate parts that are securely joined together.

The belt 12 includes a center region 20, a first elongated section 22 extending longitudinally from one side of the center region 20, and a second elongated section 24 extending longitudinally from an opposite side of the center region 20. The first and second sections 22 and 24 comprise elongated, flat strips of material arranged along the same longitudinal axis so as to define a straight line. With this arrangement, the outer or distal end of the first section 22 forms the first end 14 of the belt 12, and the distal end of the second section 24 forms the second end 16 of the belt 12. The belt 12 includes first and second longitudinal edges 26 and 28 extending between the first and second ends 14 and 16. In the illustrated embodiment, the center region 20 has a substantially circular shape that is wider than the first and second sections 22 and 24. This results in the first and second longitudinal edges 26 and 28 being nonlinear. It should be noted that other center region configurations are possible. For example, the center region 20 could have a rectangular shape the same width as the first and second sections 22 and 24 so that the belt 12 defines a strip of uniform width, with the first and second longitudinal edges 26 and 28 being linear.

The protuberance 18 is located in the center region 20 on one side 30 of the belt 12. For sake of convenience, this side will be referred to as the back side 30 and the opposing side of the belt 12 will be referred to as the front side 32. The protuberance 18 is an asymmetrical protuberance in that it is a rounded, lopsided mound having a hook-like shape as best seen in FIG. 4. More specifically, the protuberance 18 is inclined or tilted toward the first longitudinal edge 26 to define a hook-like shape designed to produce the desired upward and inward thrusts when the device 10 is used to perform the Heimlich maneuver. The center region 20 on the front side 32 is generally flat and can be adorned with a logo and/or instructions on how to use the device 10.

The belt 12 is provided with a plurality of handgrips 34 that allow a person to easily grasp the device 10 when using it to perform the Heimlich maneuver. In the illustrated embodiment, a first set of the handgrips 34 is formed in the first section 22, between the first end 14 of the belt 12 and the protuberance 18, and a second set of the handgrips 34 is formed in the second section 24, between the second end 16 of the belt 12 and the protuberance 18. The first set of handgrips 34 is arranged along a line extending from the first end 14 to the center region 20, and the second set of handgrips 34 is arranged along a line extending from the second end 16 to the center region 20. The handgrips 34 of each set are spaced apart so as to be located at successively greater distances from the corresponding end of the belt 12. This arrangement allows a user to select an appropriate “effective” length of the belt 12 (i.e., the length between the points at which the belt 12 is being held) depending on the girth of the choking victim.

Each individual handgrip 34 comprises a slot formed through the belt 12. The handgrips 34 are shown in the drawings as being crescent-shaped slots, although any suitable shape can be utilized. The slots defining the handgrips 34 should generally be large enough to receive a user's hand.

The overall length of the belt 12 should be sufficiently long so that the belt 12 will extend at least partially around the torso of a person, and thereby enable a rescuer using the device 10 to reach all the way around even a very large person. Typically, the end-to-end length of the belt 12 will be in the range of about 2-3 feet (60.96-91.44 cm), although longer lengths are possible.

The belt 12 is preferably made of a material that is lightweight, flexible and resilient, but also sturdy and durable. For example, the belt 12 can be made of a suitable rubber material and have a sufficiently small thickness so as to be flexible. As mentioned above, the device 10 can be of a one-piece or two-piece construction. In the case of a one-piece construction, the protuberance 18 will be made of the same material as the belt 12. In the case of a two-piece construction in which the belt 12 and the protuberance 18 are separate parts that are securely joined together, the belt 12 and the protuberance 18 can be, but are not necessarily, made of the same material. When the belt 12 and the protuberance 18 are made of the same material, the protuberance 18 will be generally harder and less flexible than the belt 12 because of its thicker, mounded construction. Alternatively, the protuberance 18 can be made of a material that is harder than the belt material. Furthermore, the device 10 is brightly colored, such as fluorescent orange, so as to stand out and be easily spotted during an emergency.

The belt 12, particularly the first and second elongated sections 22 and 24, have a width that is greater than the thickness of the belt 12. For instance, the section width will typically be in the range of about 4-6 inches (10.16-15.24 cm) or more. While the first and second sections 22 and 24 could be narrow strips, or even formed of cord or cable or the like, the flat, relatively wide strips of the illustrated embodiment are generally preferred because they would be less likely to cause injury to a person during use of the device 10. That is, the relatively wide first and second sections 22 and 24 will tend to spread the force out over the victim's torso when the device 10 is being is used in the manner described below. In contrast, cords or cables would concentrate the pulling force and therefore be more likely to cause damage to the victim's ribs or other body parts.

In use, a person rendering assistance to a choking victim places the device 10 around the victim's torso with the back side 30, and thus the protuberance 18, facing the victim's abdomen. The protuberance 18 is positioned just below the sternum, directly beneath the diaphragm. The device 10 should be oriented with the first longitudinal edge 26 facing upward so that the protuberance 18 is inclined in an upward direction. Standing behind the choking victim, the rescuer grasps the device 10 by inserting one of his or her hands through a selected one of the first set of handgrips 34 and the other hand through a selected one of the second set of handgrips 34. The selected handgrips 34 should such that the length of the belt 12 between the selected handgrips 34 is sufficient for the rescuer to hold the device 10 relatively tautly around the choking victim.

The rescuer then sharply pulls with both hands on the device 10, causing the protuberance 18 to be forced into the victim so as to produce an abdominal thrust. The upward facing orientation of the hook-like shape of the protuberance 18 results in an upward and inward abdominal thrust that lifts the diaphragm and forces air out of the lungs with great force to hopefully expel the airway obstruction. The protuberance 18 thus simulates the fist of a rescuer who is applying the Heimlich maneuver in the traditional, unaided manner. Although the device 10 is particularly useful in facilitating performance of the Heimlich maneuver on very large people, particularly where the rescuer would otherwise be unable to reach around the victim and perform the Heimlich maneuver in the traditional manner, it should be noted that the device 10 is not limited to use with very large people and can be beneficial when used with people of all sizes.

While specific embodiments of the present invention have been described, it should be noted that various modifications thereto could be made without departing from the spirit and scope of the invention as defined in the appended claims.

What is claimed is:

1. A flexible belt for facilitating performance of the Heimlich maneuver, said belt having first and second ends and a protuberance formed on one side of said belt between said first and second ends.

2. The belt of claim 1 wherein said protuberance is asymmetrical.

3. The belt of claim 1 wherein said protuberance has a hook-like shape.

4. The belt of claim 1 wherein said protuberance is located intermediate said first and second ends.

5. The belt of claim 1 further comprising at least one handgrip located between said protuberance and said first end and at least one other handgrip located between said protuberance and said second end.

6. The belt of claim 5 wherein said handgrips are crescent-shaped slots.

7. The belt of claim 1 wherein said belt is made of a rubber material.

8. The belt of claim 1 wherein said belt is brightly colored.

9. A device for assisting in applying abdominal thrusts to a choking victim, said device comprising:
a flexible belt including a center region, a first section extending from one side of said center region and defining a first end of said belt, and a second section extending from an opposite side of said center region and defining a second end of said belt, said belt defining first and second longitudinal edges extending between said first and second ends; and
an asymmetrical protuberance formed on said center region.

10. The device of claim 9 wherein said asymmetrical protuberance is inclined toward said first edge.

11. The device of claim 9 wherein said center region has a substantially circular shape.

12. The device of claim 9 wherein said belt is approximately 2-3 feet long.

13. The device of claim 9 wherein said first and second sections are each a flat strip of flexible material.

14. The device of claim 13 wherein said first and second sections are each approximately 4-6 inches wide.

15. The device of claim 9 further comprising a first set of handgrips formed in said first section and a second set of handgrips formed in said second section.

16. The device of claim 15 wherein said first set of handgrips is arranged along a line extending from said first end towards said center region, and said second set of handgrips is arranged along a line extending from said second end towards said center region.

17. The device of claim 15 wherein said handgrips of said first and second sets are crescent-shaped slots formed through said belt.

18. The device of claim 9 wherein said belt is made of a rubber material.

19. The device of claim 18 wherein said asymmetrical protuberance is made of a rubber material.

20. The device of claim 9 wherein said belt and said asymmetrical protuberance are brightly colored.
